(19) United States
(12) Patent Application Publication
(10) Pub. No.: US 2008/0210066 A1
(43) Pub. Date: Sep. 4, 2008

(54) Method for chopping unwound items and coated chopper blades

(76) Inventors: Russell Donovan Arterburn, Athens, TN (US); Glenn Allen Torbett, Charleston, TN (US); Jonathan Nicolas Allred, Centerville, IN (US); Jennifer Kristin Pergola, Westminster, CO (US); Jason J. Blush, Lakewood, CO (US)

Correspondence Address: JOHNS MANVILLE, 10100 WEST UTE AVENUE, PO BOX 625005, LITTLETON, CO, 80162-5005, US

(21) Appl. No.: 11/713,428

(22) Filed: Mar. 2, 2007

(51) Int. Cl. B26D 7/08

(52) U.S. Cl. 83/22; 420/430

(57) ABSTRACT

A method for separating long, unwound items like fiber, fiber strands, yarn, etc. having a liquid chemical sizing on the surfaces into short lengths by chopping is disclosed.

Improved chopping life is achieved by using blades, or at least blade edges of cemented tungsten carbide, and selecting the liquid chemical sizings having a pH of about 7 or greater to apply to the surfaces of the items being chopped. Also disclosed are blades having at least the sharp edges of the chopping blades coated with various materials including a material selected from a group consisting of tungsten carbide, titanium nitride, diamond like carbon, polycrystalline diamond, polycrystalline cubic boron nitride, cemented tungsten carbide, or mixture of two or more of these materials. These coated blades can be used to separate items having both neutral, basic and acidic sizings thereon

The present invention involves an improved chopping method for chopping continuous or very long loose items such as fiber, fiber strands, yarn, wire, string, ribbon, tape and the like by pulling the item(s) into the chopper while the loose items are held tightly against the surface of a rotating backup roll and carrying the item(s) on into a nip between a rotating blade roll and the rotating backup roll where they are separated into short pieces. The present invention also involves using choppers that wind material on the outside or inside of a rotating blade roll and separate the material into short lengths using one or more pressure rollers running on the wound material, forcing the wound material into the blade edges on the blade roll. More specifically the present invention involves an improved chopping method using an improved blade roll in combination with items to be chopped having water or protective sizings on the surface and having a pH of about 7 or higher.

### BACKGROUND

It has long been known to chop continuous fibers or fiber strands into lengths of about 1-5 inches or shorter. Billions of pounds of such product including chopped glass fibers and fiber strands are produced each year in process and chopping apparatus such as disclosed in U.S. Pat. Nos. 5,970,837, 4,551,160, 4,398,934, 3,508,461, and 3,869,268, the disclosures of which are incorporated herein by reference. The choppers disclosed in these patents comprise a blade roll containing a plurality of spaced apart blades for separating the fibers into short lengths, a backup roll, often or preferably driven, which the blades work against to effect the separation and which pulls the fibers or fiber strands and in some cases, an idler roll to hold the fibers or fiber strands down onto the surface of the backup roll. In the chopped fiber processes disclosed in these patents,.the chopper is often the item most limiting the productivity of the processes. These processes typically operate continuously every day of the year, 24 hours each day, except for furnace rebuilds every 5-10 years. It is also known to use choppers like those disclosed in U.S. Pat. Nos. 4,369,681 and 4,569,264 in which the item(s) are wound continuously on the inside or outside of a rotating blade roll and forced into the blade edges by one or more pressure rolls. These latter types of choppers also use stainless or carbon steel blades and suffer from too short of blade life as disclosed in U.S. Pat. No. 5,398,575.

Many of the above choppers use a blade roll made using an elastomeric material layer such a rubber, polyurethane, or other material having similar elastomeric properties, for holding spaced apart blades in spaced apart slots in the elastomeric layer, see U.S. Pat. Nos. 4,083,279 and 4,287,799. In a large operation, many blade rolls must be inventoried to service a plurality of choppers making several different products at any one time, one of the differences in the chopped products being length of the chopped product desired. In making up the blade rolls, blades, usually stainless steel or carbon steel blades having razor sharp edges, are placed only in the slots appropriate for making the chopped length desired for the product to be produced with those blade rolls.

These choppers run at speeds such that the surface speed of the backup roll and the edge of the blades move at thousands of feet per minute, i.e. from 2,000 to more than 6,000 feet per minute, such as 7,000 to 10,000 feet per minute. The chopping blades and the working layer of the backup roll or cot have a life, depending upon the type of item(s) being separated into short lengths with the chopper. When chopping wet, sized glass fiber strands, the average life of the blades is about 12-24 hours, and this also limits the life of the backup roll or cot to the same life because it is too expensive to have to shut down the chopper before the new blades need changing again to replace the backup roll, working layer or cot. As the blades wear, deeper engagement with the back-up roll becomes necessary to compensate for the lost blade material and larger radius edge. This increased engagement results in premature back-up roll failure. These shutdowns to replace the backup and/or blade rolls take from 2-10 minutes, sometimes longer. While the chopper is down for replacing the blade roll, and or backup roll, working layer or cot, all of the fibers from all of the fiberizing bushings serviced by the chopper, usually at least 6-10 bushings, go to scrap, i.e. shutdowns for blade replacement significantly reduces productivity and is very expensive when considering that a typical fiber manufacturing operation contains 15 or more operating choppers.

Due to the expense and lost production caused by short blade life, much searching for a better blade than stainless razor blade type blades has been undertaken. One type of blade that offered promise was a cobalt cemented tungsten carbide blade. Although this type of blade is much more expensive than stainless steel or carbon steel blades, it was thought it might provide a long enough life due to the hardness and known wear resistance of tungsten carbide that the higher cost would be more than offset by a longer chopping life, however tests resulted in blade life that, although better, was excessively variable and too short to justify the higher blade cost. It is known to use cemented tungsten carbide as fiber chopper elements as disclosed in U.S. Pat. No. 6,517,017.

### SUMMARY OF THE INVENTION

It has now been discovered that the variable and short blade life of the cobalt bonded tungsten carbide blades is due to the pH of the chemical protective sizing on the surfaces of the items being chopped. It has been discovered that when the pH of the sizing is less than about 7, especially less than about 5 and most especially less than about 4, the edge of the blade is attacked and deteriorates excessively to properly separate the items within 50 hours of chopping operation or less. If the sizing on the items being chopped is modified to increase the pH to 7 or above, the average chopping life of the tungsten blades is increased substantially, often dramatically to 500 hours or more. It has also been surprisingly discovered that with this higher blade life, the average life of the backup roll, urethane working layer or cot is dramatically increased to at least 100, and more typically at least about 200 hours or more from the previous life of 24 hours or less.

The present invention is an improved method of separating long lengths of one or more unwound items selected from a group consisting of fibers, fiber strands, wires, strings, tape(s), strip(s) and ribbon(s) into lengths in the range of about 0.07 to about 5 inches long by feeding one or more, preferably a plurality of, long lengths of one or more of the items described above into a chopper in an unwound form at speeds exceeding 500 FPM, more typically at speeds exceeding 1000 or 2000 FPM and separating the items by pressing blades in a blade roll or blades on a cutter roll, each roll containing a plurality of blades into the items, the items having a protective liquid chemical. sizing on the surface of the items, the improvement comprising that at least the blade edge portion contains a major portion of tungsten carbide, and the liquid chemical sizing has a pH of at least 7 or greater. More typically the protective sizing will have a pH of 8 or greater and most typically a pH of 8 or higher. Also, more typically the blades or at least the edge portions of the blades will have a tungsten carbide content of at least about 90 weight percent, most typically at least about 94 weight percent. The blades or blade edge portion also more typically contains a minor portion of a metal like cobalt, more typically at least about 3-15 weight percent, more typically about 3-10-12 wt. percent and most typically about 4-6-10 wt. percent to bond the particles of tungsten carbide together.

Some types of conventional choppers used in the invention pulls the item(s) into a nip between an elastomer working layer of the backup roll or cot and the chopping portion of the blades of a rotating blade roll or a rotating cutter head, the lafter usually having the blades integral with the metal roll of the cutterhead. The blade roll or cutterhead and the backup roll are typically outboard of a front of a cabinet that contains the conventional drive and roll biasing members. Another type of conventional chopper used in the invention pulls the item(s) continuously onto the inside surface or the outside surface of a rotating blade roll having a plurality of spaced apart blades around the circumference of the blade roll. The item(s) are wound onto the blade roll while one or more rotating pressure rolls press against the wound items laying against the sharp edges of the blades causing the wound items to be separated into lengths equal to or about equal to the spacing between the blade edges. Still another type of fiber chopper usable in the invention is the chopper disclosed in U.S. Pat. No. 6,517,017.

The invention also includes coated blades, and a method of separating long lengths of one or more unwound items selected from a group consisting of fibers, fiber strands, wires, strings, tape(s), strip(s) and ribbon(s) into lengths in the range of about 0.07 to about 5 inches long by feeding one or more, preferably a plurality of, long lengths of one or more of the items described above into a chopper in an unwound form at speeds exceeding 500 FPM and separating the items by pressing the coated blades in a blade roll or coated blades on a cutter roll, each roll containing a plurality of blades into the items, the improvement comprising that the blades are comprised of stainless steel or tungsten carbide or both, and at least the blade edges have a coating to protect the blade material, the coating selected from a group consisting of a major portion of tungsten carbide, titanium nitride, diamond like carbon, polycrystalline diamond, polycrystalline cubic boron nitride, cemented tungsten carbide, or mixture of two or more of these materials. When the items being chopped having a sizing on their surfaces having a pH of less than 7, cemented tungsten carbide is not desirable unless at least the working portion of the blades are coated. One coating suitable for cemented tungsten carbide blades or blade edges for operation in an acidic environment is titanium nitride. Other suitable coatings include diamond like carbon, polycrystalline diamond, polycrystalline cubic boron nitride, cemented tungsten carbide, or mixture of two or more of these materials.

The invention includes blades having at least their working portions or edge portions made from or coated with a material selected from the group consisting of metal oxides, nitrides, carbides, borides, mixtures of a metal and an oxide, nitride or carbide, tungsten carbide, titanium carbonitride, zirconium nitride, titanium aluminum nitride, chromium/boron carbide, chromium/diamond-like carbon, titanium diboride/chromium, titanium diboride/titanium carbo-nitride composite, ceramics containing binders, molybdenum, diamond, diamond-like material, silicon, silicon carbide, vanadium, tantalum, nickel, niobium, niobium/molybdenum alloys, VYDAX, PTFE, chromium, boron carbide, titanium carbide, vanadium carbide, chromium carbide, titanium nitride, chromium nitride, boron nitride, hafnium nitride, carbon nitride, alumina, silicon dioxide, titanium dioxide, zirconia, chromium oxide, hafnium, titanium, tungsten, hafnium/diamond-like carbon, niobium/diamond-like carbon, molybdenum/diamond-like carbon, vanadium/diamond-like carbon, silicon/diamond-like carbon, tantalum/diamond-like carbon, silicon carbide/diamond-like carbon, titanium or mixtures thereof, and the use of such blades to chop, break or cut items having a chemical sizing with a pH greater than 7 on their surfaces can also be used with the type of choppers disclosed in U.S. Pat. Nos. 4,369,681, 4,569,264, and 6,517,017 and also in EP 305,057 A3.

It is also believed that the blades made from cobalt bonded tungsten carbide, or carbon steel or stainless steel coated with, one or more of the acid-sensitive materials described or named in the previous paragraph can be protected by coatings of acid resistant materials named above to permit items having chemical sizings on their surfaces having a pH of less than 7 to be chopped without significantly detracting from the blade life achieved on sizings having a pH of greater than about 7.

Methods of producing coatings like tungsten carbide (without cobalt as a binder), TiN, TiC, TiCN, ZrCN, CrN, diamond-like carbon films and other materials mentioned above include generally known techniques such as chemical vapor deposition (CVD), plasma assisted CVD, physical vapor deposition (PVD), ion beam, laser ablation, RF plasma, microwave, arc discharge, and cathodic arc plasma deposition. The coating material may be deposited on the substrate via numerous techniques including sputtering, reactive sputtering, ion beam sputtering, ion plating, electron beam gun evaporation or sublimation, electron beam gun reactive evaporation or sublimation, resistive evaporation, resistive reactive evaporation, cathodic arc evaporation or chemical vapor deposition.

The invention also includes methods of separating long lengths of one or more unwound items selected from a group consisting of fibers, fiber strands, wires, strings, tape(s), strip(s) and ribbon(s) into lengths in the range of about 0.07 to about 5 inches long by feeding one or more, preferably a plurality of, long lengths of one or more of the items described above into a chopper in an unwound form at speeds exceeding 500 FPM by using the coated blades of the invention.

When the term “working edge portion” or “working portion” is used above as part of a chopper blade these terms refers to that portion of the blade that contacts, or will contact, the item(s) being chopped during the life of the blade, including after sharpening. The term “at least the edge portion” includes “working edge portion” and even more of the blade up to and including the entire blade.

When the word “about” is used herein it is meant that the amount or condition it modifies can vary some beyond that so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without unexpected characteristics, those embodiments are within the meaning of the term about as used herein. It is not difficult for the skilled artisan or others to determine whether such an embodiment is either as might be expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIG. 1 is a front view of a portion of a prior art chopper useful in the method of the invention.

FIG. 1A is an elevational perspective view of a portion of a different prior art chopper useful in the method of the invention.

FIG. 2 is a partial perspective view of one prior art blade holder for a blade roll usable in the choppers shown in FIGS. 1 and 1A.

FIG. 2A is a partial perspective view of an assembled prior art blade roll of the type used in the choppers shown in FIGS. 1 and 1A containing chopper blades.

FIG. 2B is a front view of a typical chopper blade of the invention used in the blade roll shown in FIG. 2A.

### DETAILED DESCRIPTION OF SOME EMBODIMENTS OF THE INVENTION

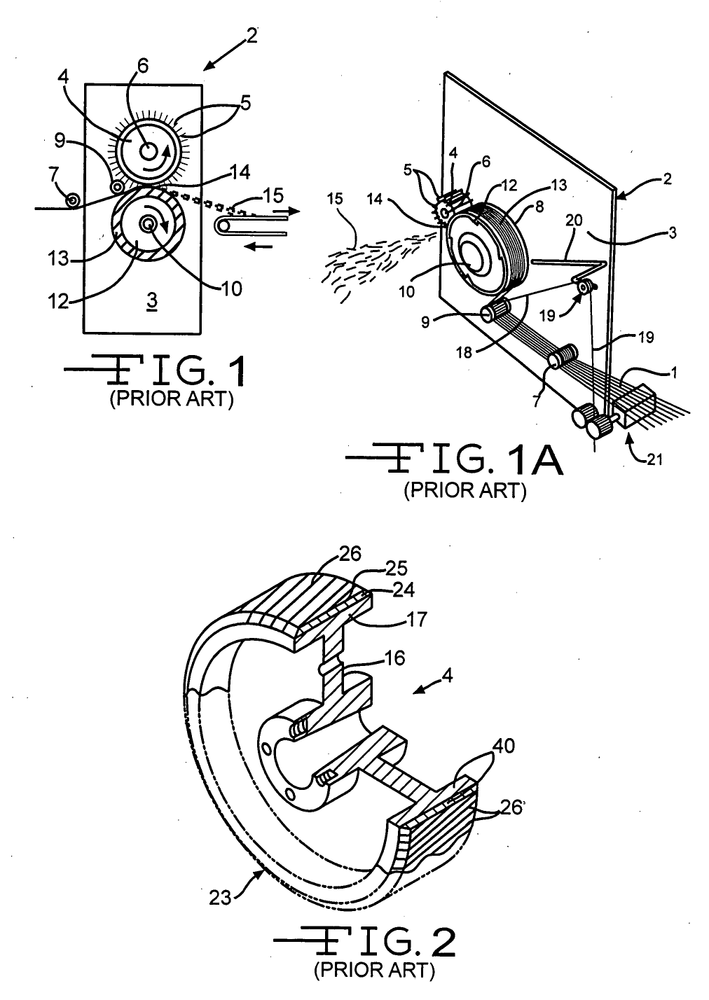

The chopper illustrated in FIG. 1, is like the chopper shown in U.S. Pat. No. 3,815,461, the disclosure of which is incorporated herein by reference. The choppers of FIGS. 1 and 1A are typical of the type of choppers suitable for use with the present invention, but other types of choppers having a blade roll with spaced apart blades that work against an elastomeric working layer of a backup roll are also usable with and in the invention. While these choppers are or will be shown pulling and chopping strands of glass fibers, these and the other suitable choppers can also be used according to the invention to pull and chop individual fibers, fiber strands of materials other than glass, wires, strings, tape(s), strip(s), ribbon(s) and similar items.

FIGS. 1 and 1A show a front elevation perspective view of a portion of a prior art chopper 2, of the type shown in U.S. Pat. Nos. 3,815,461 and 4,551,160 respectively, and that are used in making chopped strand glass fiber 15. They each comprise a cabinet front 3, a blade roll 4 with spaced apart blades 5 contained in slots and projecting from the periphery of an integrated hub 6, a backup roll 8 and a free-wheeling idler roll 9. The blade roll 6, cutter roll, can be made entirely of metal, with the blades separate or integral with the roll 6, but can be made using a thermoplastic material to hold spaced apart blades such as the blade rolls shown in U.S. Pat. Nos. 4,083,279, 4,249,441, 4,287,799 and 5,894,773, the disclosures of which are herein incorporated by reference. A backup roll 12 is held on a spindle and hub 10. The backup roll 12 has an elastomer working layer 13 that is biased against the blade roll 4 until the blades 5 press into the working layer 13 of the backup roll 12 a proper amount forming a nip 14 to break or separate fiber strands 1 into an array of short length or chopped strands 15.

One or more, usually five or more and up to 14 or more strands 1, such as glass fiber strands, each strand containing 400-6000 or more fibers and usually having water and/or an aqueous chemical sizing on their surfaces, are pulled by the backup roll 12 into the chopper 2 and the nip 14. The strands 1 first run under a grooved guide roll 7, preferably with one or two strands 1 in each groove, partially around an idler roll 9 and upward and over the elastomeric working surface 13 of the backup roll 12, i.e. the exposed peripheral surface of the backup roll 12 on which the running strands 1 lay against and are supported while being severed by blades 5 on the blade roll 4. The working surface of the back up roll 12 is typically wider than the oscillating path of the glass fiber strands 1. The strands 1 then pass under the outer surface of the free-wheeling idler roll 9 located to provide sufficient contact of the strands 1 on the surface of the working layer 13 on the backup roll 12 enabling the latter to pull the glass fiber strands 1 into the chopper 2.

When a new strand 18 is ready to be started into the prior art chopper 2 shown in FIG. 1A, it is pulled to the front of the chopper 2 by the operator and pulled under the separator roll 7 and the idler roll 9 and up over a fixed, preferably non-freewheeling starter roll 19 attached to the end of a pivoting arm 20 and down between a nip of a pair of driven pull rolls 21 that pull the new strand 18 at a first low speed and deliver the new strand into a conventional scrap processing system, scrap bin or scrap basement. After the new strand 18 is being pulled by the pull roll assembly 21 at a low initial speed, the pulling speed of the pull rolls 21 is ramped up to bring the new strand 18 to at least close to the speed of the strands 1 running into the chopper 2. When that speed is reached, the pivot arm 20 is pivoted counterclockwise to start the new strand 18 into the chopper 2 in the manner disclosed in U.S. Pat. No. 4,551,160.

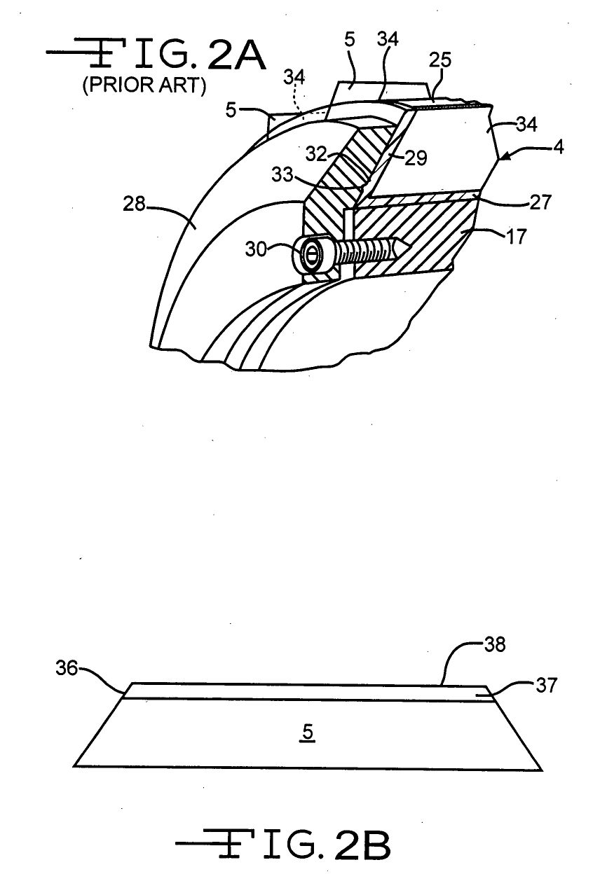

FIG. 2 shows a typical blade roll wheel 23 for a blade roll 4, without the blades 5. A portion of the blade roll 23 is cut away to better illustrate the blade roll assembly. The blade roll 4 is typically comprised of a hub supporting a rim 17. The rim 17 holds an elastomeric working layer that the chopper blades 5 work against. The blades 5 usually must penetrate the top surface 25 a desired distance as is well known to chop all the fibers or other items. The chopping blades 5 sit in slots 26 that extend part of the way through the thickness of the working layer 24, usually half way or more through the thickness of the working layer 24, and rest on the bottom of the slots 27. The working layer 24 can be most any elastomeric material having a hardness sufficient to hold the blades and typically is a polyurethane or rubber material. FIG. 2A, a partial perspective view of the same blade roll wheel 23 as shown in FIG. 2, has blades 5 in some or all of the slots 24 of the working layer 24 and a blade retention ring 28 held in place on the blade roll wheel 23 with bolts 30 that screw into threaded holes 31 in the rim 17 of the blade roll wheel 23. The blades 5 are held securely in place as the blade retention rings 28 (the blade retention ring on the backside of the backup roll 4 is not shown, but is just like the front blade retention ring 28 that is shown) with a cushion ring 29 of compressible material as shown and described in U.S. Pat. No. 4,249,441, the disclosure thereof being incorporated herein by reference. The cushion ring 29 is held in place with an annular bead 32 that fits into an annular groove 33 in an inner face of the blade retention ring 28.

It is very costly and storage space intensive to inventory slotted blade rolls 4 for every length of item that will be produced in a reasonable period of time, particularly considering the life of a blade roll, about 4-36 hours, usually averaging about 12-24 hours, depending on the item and type of product being produced, and the large number of choppers required for a typical manufacturing company, typically about 4-50 choppers or more, usually more than 10-20 choppers. The product lengths of the separated items, and therefore the center to center distance between the slots 26, will typically include about 25-26 mm, about 30-35 mm and about 40-55 mm and greater, but other chopped lengths are also frequently required.

FIG. 2B shows a typical blade 5 used in the choppers shown in FIGS. 1, 1A and 1B. This is one suitable shape used, but the shape or size of the blades is not critical as many shapes and sizes can be used in various blade roll designs as is well known. In the past these blades have been made from razor blade quality stainless or carbon steel and this has been the standard for many years. The top edge 36 of the blade is ground to a sharp edge, starting from a short distance back from the edge at 37, normally at least a distance in the range of about 1 to about 12 mm, more typically about 2-7 mm, and having a tapered portion 36 ending at the sharp edge 38. The edge of the blades that contact the item to be separated is razor blade sharp when the blade is new.

Work has been done to find a blade that would last considerably longer than the average 12-24 hours of the stainless or carbon steel blades. Tungsten carbide is a very hard material and has been used extensively in metal machining and other applications where severe wear problems occur. But, when blades containing about 90-95 tungsten carbide particles an bonded together with a cobalt matrix amounting to about 5-10 wt. percent, and manufactured by Turmond of Via Lanzo, Italy and named Turmond-H, were trialed in choppers like those shown in FIG. 1 chopping wet glass fiber having a chemical sizing on their surfaces, the life of the blades, although greater than the life of stainless steel, was not sufficient to justify the much higher cost of these blades compared to the much less expensive stainless steel blades.

It has now been discovered that the reason the life of the Turmond-H blades was not longer was due to acid attack on the blade edges. The acid attack was due to the chemical sizing on the fiber, the chemical sizing had a pH of less than 4. When the chemical sizing was modified to have a pH of greater than 7, and the Turmond-H blades retrialed, the life of the blades rose to more than 500 hours. Also, the life of the polyurethane working layer 13 of the backup roll 12 also doubled and tripled. More trials confirmed these initial results. With the longer blade life and longer polyurethane working layer life of the backup rolls, the higher cost of the tungsten carbide-cobalt bonded blades is now economical.

The worn tungsten carbide containing blades can be resharpened by grinding in a conventional manner and that the re-sharpened blades cost only about 0.33 times the original blade cost. There is a limit to how many times the W2C blades can be re-sharpened, but they can be sharpened at least about 5 times.

The invention includes blades having their working portions coated with a material selected from the group consisting of metal oxides, nitrides, carbides, borides, mixtures of a metal and an oxide, nitride or carbide, tungsten carbide, titanium carbonitride, zirconium nitride, titanium aluminum nitride, chromium/boron carbide, chromium/diamond-like carbon, titanium diboride/chromium, titanium diboride/titanium carbo-nitride composite, ceramics containing binders, molybdenum, diamond, diamond-like material, silicon, silicon carbide, vanadium, tantalum, nickel, niobium, niobium/molybdenum alloys, VYDAX, PTFE, chromium, boron carbide, titanium carbide, vanadium carbide, chromium carbide, titanium nitride, chromium nitride, boron nitride, hafnium. nitride, carbon nitride, alumina, silicon dioxide, titanium dioxide, zirconia, chromium oxide, hafnium, titanium, tungsten, hafnium/diamond-like carbon, niobium/diamond-like carbon, molybdenum/diamond-like carbon, vanadium/diamond-like carbon, silicon/diamond-like carbon, tantalum/diamond-like carbon, silicon carbide/diamond-like carbon, titanium or mixtures thereof, to chop, break or cut items having a chemical sizing with a pH of 7 or greater than 7 on their surfaces. These coated blades can also be used with the type of choppers disclosed in U.S. Pat. Nos. 4,369,681, 4,569,264, and 6,517,017 and also in EP 305,057 A3.

It is also believed that the blades made from cobalt bonded tungsten carbide, or carbon steel or stainless steel coated with, one or more of the acid-sensitive materials described or named in the previous paragraph can be protected by coatings of acid resistant materials named above to permit items having chemical sizings on their surfaces having a pH of less than 7 to be chopped without significantly detracting from the blade life achieved on sizings having a pH of greater than about 7.

Methods of producing coatings like tungsten carbide (without cobalt as a binder), TiN, TiC, TiCN, ZrCN, CrN, diamond-like carbon films and other materials mentioned above include known techniques such as chemical vapor deposition (CVD), plasma assisted CVD, physical vapor deposition (PVD), ion beam, laser ablation, RF plasma, microwave, arc discharge, and cathodic arc plasma deposition. The coating material may be deposited on the substrate via numerous techniques including sputtering, reactive sputtering, ion beam sputtering, ion plating, electron beam gun evaporation or sublimation, electron beam gun reactive evaporation or sublimation, resistive evaporation, resistive reactive evaporation, cathodic arc evaporation or chemical vapor deposition.

Different embodiments employing the concept and teachings of the invention will be apparent and obvious to those of ordinary skill in this art and these embodiments are likewise intended to be within the scope of the claims. The inventor does not intend to abandon any disclosed inventions that are reasonably disclosed but do not appear to be literally claimed below, but rather intends those embodiments to be included in the broad claims either literally or as equivalents to the embodiments that are literally included.

1. A method of separating long lengths of one or more unwound items selected from a group consisting of fibers, fiber strands, wires, strings, tape(s), strip(s) and ribbon(s) into lengths in the range of about 0.07 to about 5 inches long by feeding one or more, preferably a plurality of, long lengths of one or more of the items described above into a chopper in an unwound form at speeds exceeding 500 FPM and separating the items by pressing blades in a blade roll or blades on a cutter roll, each roll containing a plurality of blades into the items, the items having a protective liquid chemical sizing on the surface of the items, the improvement comprising that the blade edges contain a material selected from a group consisting of a major portion of tungsten carbide, titanium nitride, diamond like carbon, polycrystalline diamond, polycrystalline cubic boron nitride, cemented tungsten carbide, or mixture of two or more of these materials, and the liquid chemical sizing is selected having a pH of 7 or greater.

2. The method as described in claim 1 wherein the liquid chemical sizing has a pH of about 8 or greater.

3. The method as described in claim 1 wherein the liquid chemical sizing has a pH of about 9 or greater.

4. The method of claim 1 wherein the blade edges have a tungsten carbide content of at least about 90 weight percent.

5. The method of claim 1 wherein the edges of the blades have a tungsten carbide content of at least about 94 weight percent.

6. The method of claim 2 wherein the edges of the blades have a tungsten carbide content of at least about 94 weight percent.

7. The method of claim 3 wherein the edges of the blades have a tungsten carbide content of at least about 94 weight percent.

8. The method of claim 4 wherein the edges of the blades have a cobalt content of about 5-10 wt. percent.

9. The method of claim 5 wherein the edges of the blades have a cobalt content of about 4-6 wt. percent.

10. The method of claim 6 wherein the edges of the blades have a cobalt content of about 4-6 wt. percent.

11. The method of claim 7 wherein the edges of the blades have a cobalt content of about 4-6 wt. percent.

12. The method as described in claim 1 in which the items enter the chopper at a speed of at least 1000 FPM.

13. The method as described in claim 2 in which the items enter the chopper at a speed of at least 1000 FPM.

14. The method as described in claim 1 in which the items enter the chopper at a speed of at least 2000 FPM.

15. The method as described in claim 2 in which the items enter the chopper at a speed of at least 2000 FPM.

16. A method of separating long lengths of one or more unwound items selected from a group consisting of fibers, fiber strands, wires, strings, tape(s), strip(s) and ribbon(s) into lengths in the range of about 0.07 to about 5 inches long by feeding one or more, preferably a plurality of, long lengths of one or more of the items described above into a chopper in an unwound form at speeds exceeding 500 FPM and separating the items by pressing blades in a blade roll or blades on a cutter roll, each roll containing a plurality of blades into the items, the items having a protective liquid chemical sizing on the surface of the items, the improvement comprising that at least the working blade edge has a coating to protect the blade working edge, the coating material selected from a group consisting of
metal oxides, nitrides, carbides, borides, mixtures of a metal and an oxide, nitride or carbide, tungsten carbide, titanium carbonitride, zirconium nitride, titanium aluminum nitride, chromium/boron carbide, chromium/diamond-like carbon, titanium diboride/chromium, titanium diboride/titanium carbo-nitride composite, ceramics containing binders, molybdenum, diamond, diamond-like material, silicon, silicon carbide, vanadium, tantalum, nickel, niobium, niobium/molybdenum alloys, VYDAX, PTFE, chromium, boron carbide, titanium carbide, vanadium carbide, chromium carbide, titanium nitride, chromium nitride, boron nitride, hafnium nitride, carbon nitride, alumina, silicon dioxide, titanium dioxide, zirconia, chromium oxide, hafnium, titanium, tungsten, hafnium/diamond-like carbon, niobium/diamond-like carbon, molybdenum/diamond-like carbon, vanadium/diamond-like carbon, silicon/diamond-like carbon, tantalum/diamond-like carbon, silicon carbide/diamond-like carbon, titanium or mixtures thereof.

17. The method of claim 16 wherein a major portion of the blade is tungsten carbide and the coating is selected from the group consisting of titanium nitride, diamond like carbon, polycrystalline diamond, polycrystalline cubic boron nitride, cemented tungsten carbide, or mixture of two or more of these materials, and the liquid chemical sizing is selected having a pH of less than 7.

18. The method of claim 16 wherein the coating contains titanium nitride.

19. The method of claim 17 wherein the pH is less than 5 and the coating contains titanium nitride.

20. The method of claim 16 wherein the coating contains diamond like carbide.

21. The method of claim 17 wherein the pH is less than 5 and the coating contains diamond like carbide.

22. A blade having a sharp edge along one side for separating long lengths of one or more unwound items selected from a group consisting of fibers, fiber strands, wires, strings, tape(s), strip(s) and ribbon(s) into lengths in the range of about 0.07 to about 5 inches long with the long lengths moving at a speed of at least about 500 FPM, the blade having at least its working portion coated with a material selected from the group consisting of metal oxide, nitride, carbide, boride, mixtures of a metal and an oxide, nitride or carbide, tungsten carbide, titanium carbonitride, zirconium nitride, titanium aluminum nitride, chromium/boron carbide, chromium/diamond-like carbon, titanium diboride/chromium, titanium diboride/titanium carbo-nitride composite, ceramics containing binders, molybdenum, diamond, diamond-like material, silicon, silicon carbide, vanadium, tantalum, nickel, niobium, niobium/molybdenum alloys, VYDAX, PTFE, chromium, boron carbide, titanium carbide, vanadium carbide, chromium carbide, titanium nitride, chromium nitride, boron nitride, hafnium nitride, carbon nitride, alumina, silicon dioxide, titanium dioxide, zirconia, chromium oxide, hafnium, titanium, tungsten, hafnium/diamond-like carbon, niobium/diamond-like carbon, molybdenum/diamond-like carbon, vanadium/diamond-like carbon, silicon/diamond-like carbon, tantalum/diamond-like carbon, silicon carbide/diamond-like carbon, titanium or mixtures thereof.

23. The blade of claim 22 wherein a major portion of the working portion of the blade is tungsten carbide and the coating is selected from the group consisting of titanium nitride, diamond like carbon, polycrystalline diamond, polycrystalline cubic boron nitride, cemented tungsten carbide, or mixture of two or more of these materials.

24. The blade of claim 22 wherein the coating contains titanium nitride.

25. The blade of claim 23 wherein the coating contains titanium nitride.

26. The blade of claim 22 wherein the coating contains diamond like carbide.

27. The blade of claim 23 wherein the coating contains diamond like carbide.

28. The blade of claim 23 wherein the working portion of the blade material contains about 3 to about 10 wt. percent of cobalt.

29. The blade of claim 25 wherein the working portion of the blade material contains about 3 to about 10 wt. percent of cobalt.

30. The blade of claim 27 wherein the working portion of the blade material contains about 3 to about 10 wt. percent of cobalt.
